(19) United States
(12) Patent Application Publication
(10) Pub. No.: US 2010/0141466 A1
(43) Pub. Date: Jun. 10, 2010

(54) System and method for automatic detection of fiber and copper in data switch systems

(76) Inventors: Mary Thanhhuong Thi Nguyen, Milpitas, CA (US); Patrick Chung-You Liu, Naperville, IL (US)

Correspondence Address: SCHWABE, WILLIAMSON & WYATT, P.C., 1420 FIFTH, SUITE 3010, SEATTLE, WA, 98101, US

(21) Appl. No.: 10/116,899

(22) Filed: Apr. 5, 2002

(51) Int. Cl. G08B 21/00

(52) U.S. Cl. 340/687

(57) ABSTRACT

A system and method automatically maintains data indicating a type of transmission medium connected at a port in a data switch device. The method comprises reading first transmission medium type data representing whether a first transmission medium type is connected to the port. A check is performed to determine whether a stored first transmission medium value is updated based at least in part on the first transmission medium type data, the first transmission medium value representing whether the first transmission medium type is actively connected. The method also involves reading second transmission medium type data representing whether a second transmission medium type is connected to the port. A check is performed to determine whether a stored second transmission medium value is updated based at least in part on the second transmission medium type data, the second transmission medium value representing whether the second transmission medium type is actively connected.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to telecommunications and data networks. More particularly, the present invention relates to systems and methods for determining and maintaining the type of transmission medium, e.g., fiber or copper, connected to ports comprising a data switch system.

Ethernet technology is one of the most widely used networking standards across the world. At the heart of this standard is the Carrier Sense Multiple access with Collision Detection (CSMA/CD) protocol. The CSMA/CD protocol is used to pass messages between computers communicating on a network. One common Ethernet infrastructure, referred to as 10BASE-T, consists of coaxial or twisted pair copper cable that provides transmission speeds up to 10 megabits per second (Mbps). 100BASE-T, also referred to as Fast Ethernet, increases transmission speeds to 100 Mbps. Workstations equipped with 10BASE-T network interfaces may typically connect to a 100BASE-T network, albeit at a transmission ceiling of 10 Mbps.

Advances in Ethernet technology have led to the introduction of Gigabit Ethernet technology, which uses the same frame format and protocol as that introduced in IEEE 802.3, that allows data transmission speeds of up to one gigabit per second; one gigabit is equal to one billion bits. Although Gigabit Ethernet technology may operate with twisted pair transmission media, the most favorable transmission speeds are achieved through the use of optical fiber media. Optical fiber, typically comprising a glass or synthetic fiber consisting of an inner core and outer cladding, is used to carry pulses of light that encode digital data.

Because existing Gigabit Ethernet infrastructure may interface with both fiber and copper transmission media, network administrators or software processes must constantly be aware of the media type connected to any given port on a data switch system. Failing to recognize the type of transmission media connected to a port ultimately results in a highly inefficient use of bandwidth. For example, unaware of the transmission medium connected to a port, a process might schedule video for transmission over a given random port. The high bandwidth video transmission, however, is much better suited for transmission over a fiber connection. Scheduling the video transmission on any given random port results in bandwidth intensive data being transmitted over a copper connection when the possibility exists that a fiber port is available. Likewise, low bandwidth transmissions suited for delivery over a copper connection are transmitted over high bandwidth fiber connections at least a portion of the time.

In order to determine the transmission medium that is connected to any given port in a data switch system, specialized chips have been developed in order to sense the connected media and utilize an appropriate physical interface within the port. One exemplary solution is presented by Marvell International Ltd., which has developed the Alaska Ultra+ Gigabit Ethernet transceiver. According to Marvell, the Alaska Ultra+“automatically senses whether the end-user has inserted a . . . copper or fiber-optic cable, performs Auto-Negotiation and provides seamless ‘plug and play’ configuration.” One overriding deficiency to existing solutions such as the one provided by Marvell, however, is that they do not provide real-time data regarding the overall state of all ports comprising a data switch system or determine whether fiber or copper is actively connected to each port at a given time. Furthermore, these solutions do not take into account situations where media of a particular type is removed from a port.

There is thus a need for a system and method that automatically detects and records changes in the transmission medium attached to the ports comprising a data switch system.

### BRIEF SUMMARY OF THE INVENTION

In accordance with the present invention, the above and other problems with existing systems are solved by methods and systems for maintaining transmission medium data for each port in a data switch device. In one aspect of the invention, the data switch device, such as a switch, router, or bridge, contains means for detecting whether fiber or copper has been connected to each of its ports and for storing resulting fiber signal data and copper signal data. A method in accordance with the invention involves, at a regular time interval and for each port, reading the stored fiber signal data and copper signal data and, based at least in part on the read fiber signal data and copper signal data, determining whether fiber or copper is actively connected to each port at a given time. This determination may also be made by reading link data indicating whether the port is active. Temporary storage portions in memory are updated with fiber active connection status data and copper active connection status data for each port, and the fiber active connection status data and copper active connection status data is then stored in a dedicated storage location in memory.

As a result, the data switch device has access to real-time, updated data indicating whether each of its port is connected to a fiber or copper transmission medium. This data may be used, for example, to adjust data transmission rates or allocate ports to different tasks based on their bandwidth requirements.

In some embodiments, the fiber and copper active connection status data is stored in fiber up and copper up registers, respectively, which may be portions of a volatile memory device temporarily assigned and dedicated for this purpose. These fiber up and copper up registers have multiple bits, with each bit representing the fiber or copper connection status, respectively, for a given port. Data in the fiber up and copper up registers is regularly moved into a dedicated hardware register such as an LED device register. This dedicated register has multiple bits, with some bits reserved for storing the fiber status data for the ports and other bits reserved for copper status data.

In alternate embodiments, the processes described herein, including the method just described, are performed by a processor within the data switch executing a software program.

In accordance with another aspect of the invention, a method is provided for automatically maintaining data indicating a type of transmission medium connected at a port in a data switch device. The method involves:

(a) reading first transmission medium type data representing whether a first transmission medium type has been connected to the port;

(b) determining whether a stored first transmission medium value is up to date based at least in part on the first transmission medium type data, the first transmission medium value representing whether the first transmission medium type is actively connected to the port, and, if necessary, updating the stored first transmission medium value;

(c) reading second transmission medium type data representing whether a second transmission medium type has been connected to the port; and

(d) determining whether a stored second transmission medium value is up to date based at least in part on the second transmission medium type data, the second transmission medium value representing whether the second transmission medium type is actively connected to the port, and, if necessary, updating the stored second transmission medium value. According to embodiments of the invention, steps (a) through (d) are repeated. Alternatively, steps (a) through (d) may be repeated at regular intervals.

In some embodiments, steps (a) through (d) are continuously repeated while the LQ data switch device is powered on to thereby maintain transmission medium data on a continuous, real-time basis. Also, steps (a) through (e) may be performed for each of a plurality of ports in the data switch device. The steps may be performed in the sequence set forth above for each port, on a port-by-port basis, or steps (a) and (b) may be performed for all the ports followed by steps (c) and (d) being performed for the ports. In some embodiments, the port is initialized to send and receive data over the first transmission medium type if the first transmission medium value needs to be updated to indicate that the first transmission medium is actively connected to the port. This occurs, for example, if the method detects a new fiber connection to the port.

Two transmission medium types which may be detected using the current methodology include optical fiber and copper. The invention may be used to automatically detect more or other different transmission medium types, including two or more different types of fiber, two or more different types of copper, a hybrid fiber-coax connection, and others. When fiber and copper are being detected, the transmission medium type data may be stored in a fiber signal register and a copper signal register. In some embodiments, fiber may be given priority over copper, to the extent that detecting and updating an active copper connection requires a double check on whether the first transmission medium value indicates that fiber is actively connected to the port. The second transmission medium value is updated for a copper connection only if the first transmission medium value indicates that fiber is not actively connected to the port.

The present invention also provides a system for automatically maintaining transmission medium data for a port in a data switch device. The system includes a first register in a memory device for storing a first transmission medium value representing whether a first transmission medium is actively connected to the port and a second register in a memory device for storing a second transmission medium value representing whether a second transmission medium is actively connected to the port. The system further includes a third register located at a dedicated address in a memory device for storing values from the first and second register. Program code, stored in a memory device and executable by a processor, reads first and second transmission medium type data representing whether first and second transmission medium, respectively, has been connected to the port, and, based at least in part of the first and second transmission medium type data, accurately maintains the first and second transmission medium values in the first and second registers, respectively, at a regular time interval.

In some embodiments, the first and second registers each has a plurality of bits, each bit representing the transmission medium value for one of a plurality of ports in the data switch device. The third register has a number of bits at least equal to the numbers of bits in the first and second registers. The bits in the third register may include a first set of bits dedicated to storing first transmission medium values moved from the first register and a second set of bits dedicated to storing second transmission medium values moved from the second register. As a result, different sections of the third register may be accessed separately to determine which transmission medium type is actively connected at a given time.

The system may include a number of other registers, such as a link data register for storing a link data value representing whether the port is active. The stored program code actively maintains the first and second transmission medium values based at least in part on the link data value.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a 10/100 megabit data switch device;

FIG. 2 is a block diagram presenting a gigabit fiber data switch device;

FIG. 3 is a block diagram presenting a gigabit copper data switch device;

FIG. 4 is a block diagram presenting a hybrid copper/fiber data switch device according to one embodiment of the present invention;

FIG. 5 is a flow diagram presenting a scheduler operating according to one embodiment of the present invention;

FIG. 6 is a block diagram presenting a series of data registers for managing and storing the transmission medium connected to a data port according to one embodiment of the present invention;

FIG. 7 is a flow diagram presenting a method for initially determining the transmission medium connected to a data port according to one embodiment of the present invention;

FIG. 8 is a flow diagram continuing a method for initially determining the transmission medium connected to a data port according to one embodiment of the present invention;

FIG. 9 is a flow diagram presenting a process for automatically detecting the type of transmission medium connected to a data port at the time connection is performed, according to one embodiment of the present invention;

FIG. 10 is a flow diagram presenting a method for automatically detecting and recording a transmission medium change from fiber to copper according to one embodiment of the present invention; and

FIG. 11 is a flow diagram presenting a method for automatically detecting and recording a transmission medium change from copper to fiber according to one embodiment of the present invention.

### DETAILED DESCRIPTION OF THE PREFERRED EMBODIMENTS

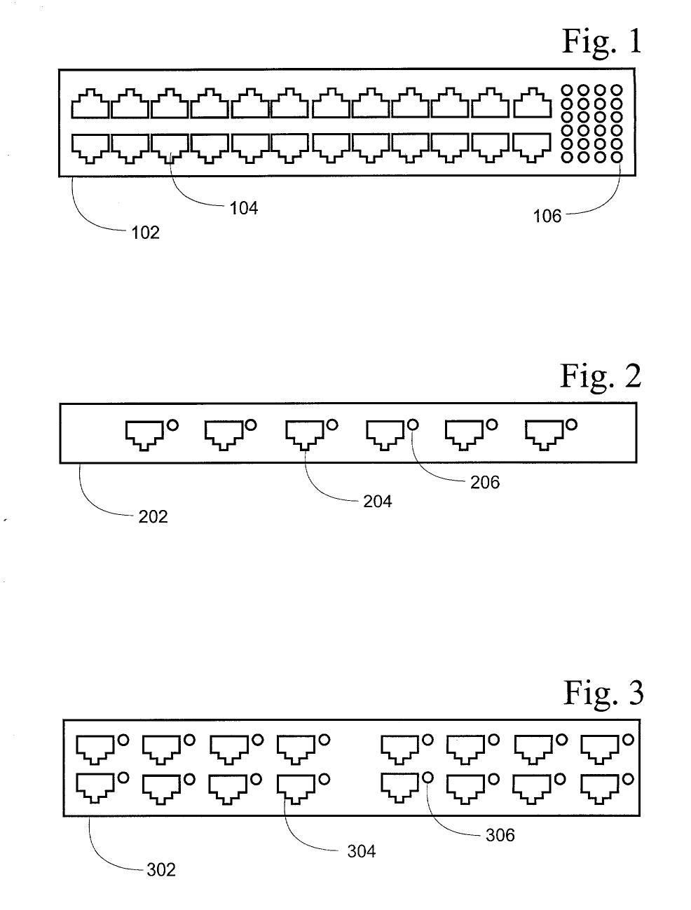

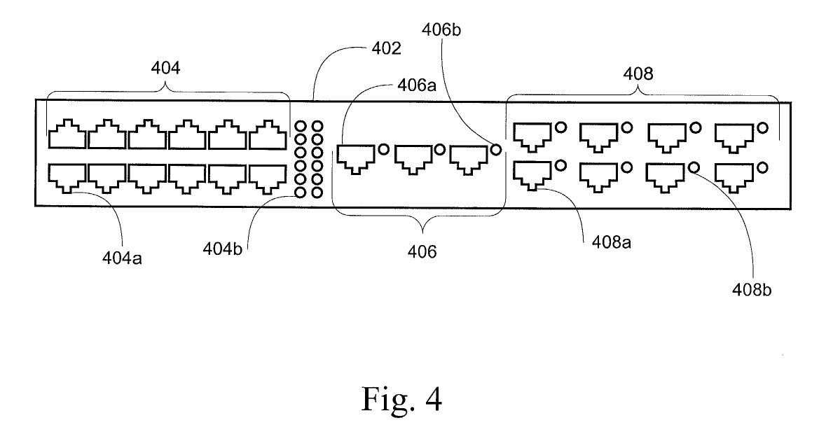

With reference to FIGS. 4 through 11, embodiments of the present invention are explained. Turning to FIG. 1, an existing configuration of a 10/100 megabit Ethernet switch is presented. The 10/100 megabit switch 102 comprises a plurality of ports 104, each supplying network connectivity to a connected device (not pictured). Depending on the network interface hardware employed at the connecting device, e.g., a workstation's network interface card, connection speeds are provided that range from 10 million bits per second (10 megabits) to 100 million bits per second (100 megabits). Data switch systems such as these typically utilize twisted pair copper cable terminated with a RJ-45 connector to provide a link between a workstation and the switch 102. Software operating at the switch 102 senses the attached network interface hardware and selects the proper connection speed. Software operating at the switch 102 further detects a connection at a given port 104, which is used to illuminate a light emitting diode (LED) 106 corresponding to the given port 104.

FIGS. 2 and 3 present different versions of existing Gigabit Ethernet data switch systems that may be used to provide connected devices with data transfer rates up to one billion bits per second (one gigabit). FIG. 2 is a Gigabit Ethernet switch 202 that uses a fiber optic transmission medium to transfer data between the switch 202 and a connected device (not pictured). A plurality of ports 204 are provided by the switch 202, each port allowing a fiber optic cable to be connected to the switch 202 at a given port 204. When a fiber optic cable is attached to a given port 204, software operating at the switch 202 detects the connection and illuminates an LED 206 corresponding to the given port 204. Similarly, Gigabit Ethernet switches such as the one presented in FIG. 3 are provided whereby the switch 302 comprises a plurality of ports 304 that each accept a copper cable connection. Software at the switch 302 detects when a copper cable is attached to a given port 304, causing illumination of an LED 306 corresponding to the given port 304.

FIG. 4 illustrates a hybrid data switch system that builds on various existing data switch systems presented in FIGS. 1 through 3. The switch 402 provide a variety of transmission speeds, depending on the network interface employed at the connecting device and the given port on the switch that the device is connected to. The present switch 402 is divided into three regions, 404, 406 and 408, each region providing ports configured to accept different transmission media and provide varying transmission speeds. According to alternative embodiments of the data switch system 402, each port on the switch is operative to accept both copper and fiber optic cable connections and differentiate between the two. As previously described, the Alaska Ultra+Gigabit Ethernet controller by Marvell, a technical specification of which is available at http://www.marvell.com/Products/Doc Files/1897/mv1-88e1011s.pdf and is hereby incorporated by reference in its entirety, is one example of a circuit capable of detecting the type of transmission medium attached to a given port.

The first region 404 provides 10/100 Mbps transmission speeds. Each port 404a in the region 404 accepts a copper cable, typically fitted with a RJ-45 connector at each end. Software at the switch 402 detects the attachment of a copper connection and illuminates a corresponding LED 404b. The second region 406 consists of ports 406a configured to accept fiber optic transmission media, typically providing data transmission rates of up to 1 gigabit. Connection of a fiber optic cable to a given port 406a causes software at the switch to illuminate an LED 406b corresponding to the given port. A third region of ports 408 also provides gigabit transmission rates, with each port 408a configured to accept copper transmission media. As is the case with the other regions, software at the switch detects insertion of a copper connection at a given port 408a and illuminates a corresponding LED 408b. Embodiments of the invention also provide for illuminating the LED corresponding to a given port only when there is a live connection. Alternatively, multistate LEDs may be used with one color indicating a link and a second color indicating data transfer. According to still other embodiments, multiple LEDs may be used, e.g., a first LED indicating a link and a second LED indicating data transfer.

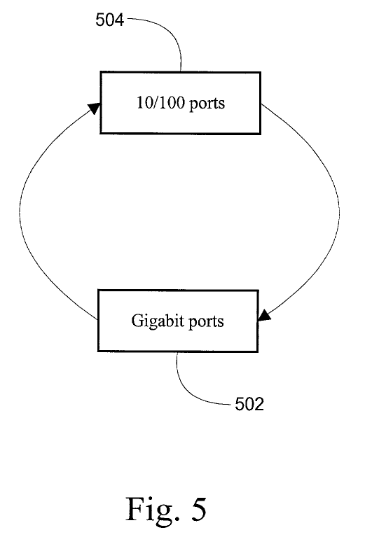

In accordance with the invention, a scheduler is employed to determine and record the type of transmission medium attached to a given port on a switch. Turning to FIG. 5, a flow diagram is presented that illustrates a process for checking the availability and type of transmission media at a given port on a data switching system. The scheduling process, which may be executed by software running remotely or on the data switch device, is used to trigger the processes detailed in the figures contained herein. The scheduling process triggers a routine to determine and record the transmission media attached to ports comprising a data switch device that provide gigabit transmission speeds, step 502. The scheduling process also triggers a routine to determine and record the transmission media attached to ports comprising a data switch device that provide megabit transmission speeds, step 504. The process repeats in a cyclical fashion to constantly update a series of registers or data structures that record the transmission medium attached to all ports comprising a data switch device. According to alternative embodiments, the ports providing megabit transmission speeds are checked, step 504, before the ports providing gigabit transmission speeds, step 502.

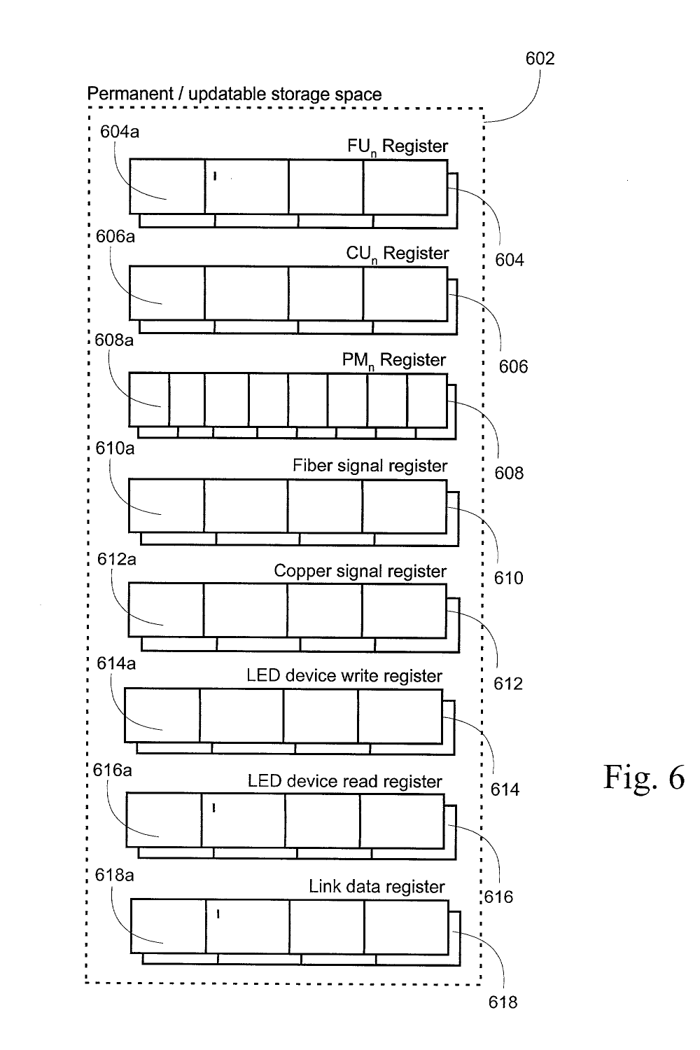

Maintained within the memory of a data switch device such as those presented in FIGS. 1 through 4 are a series of registers, which are presented in FIG. 6. The registers 604, 606, 608, 610, 612, 614, 616 and 618, are maintained in a permanent and updateable storage space, such as a transient memory circuit or hard disk drive. The memory 602 may be any transient or persistent memory structure. According to one embodiment of the invention, each register comprises a plurality of four bit registers where each bit corresponds to a port on the switch. Four bit groupings are a convenient measure, as many data switch devices comprise ports organized into four port slots. Alternatively, each register may comprise a plurality of eight bit registers, etc. As is explained herein in greater detail, the port mask register 608 is twice the size of the combination of both the fiber up and copper up registers, 604 and 606 respectively. For example, where the fiber up 604 and copper up 606 registers are each four bits, the port mask register 608 is eight bits.

Two registers are provided to track fiber and copper active connection status data, 604 and 606 respectively. Each register 604 and 606 is operative to maintain multiple bits, 604a and 606a, wherein each bit represents the fiber or copper connection status, respectively, for a given port. A port mask register 608 is provided as a temporary structure to hold bits representing the transmission media attached to any given port in a data switch device before the data is written to a permanent structure that may be accessed by other processes that require the transmission media information.

Also maintained within the memory space 602 are fiber and copper signal registers, 610 and 612 respectively. Data received by the switch from a circuit operating at each port on the data switch device, e.g., Marvell Alaska Ultra+, indicates whether a given port is connected to fiber or copper transmission media. For a given port, a bit 610a and 612a is set in either the fiber 610 or copper 612 signal register, depending on the connected transmission media. Where no transmission media is connected to a given port, the port's entry 610a and 612a in both registers 610 and 612 is left empty to indicate that no connection is present.

LED device write and read registers, 614 and 616 respectively, are also provided by the switch and maintained within the memory space 602, which according to some embodiments of the invention is a single dedicated storage location within memory. For a given port, the switch calculates whether the link over the port is up or down. Where the link is up, a bit 616a is set in the LED device read register 616 to indicate this state. Similarly, the LED device write register 614 maintains a series of bits, the presence or absence of which indicates whether a given port is on or off. Where a given port is on, a bit 614a is set in the LED device write register 614 to indicate this state. Additionally, a link data register 618 maintains a storage space for each port in the data switch device to record the presence or absence of data flow on a given port. Activity on a given port causes software at the switch to set a bit 618a in the link data register 618 for the given port, signifying that data is passing through the given port. According to embodiments of the invention, each LED register is associated with an LED or LED mode displayed on the face of a switch and is used to properly set the LED, e.g., a particular color or absence thereof as indicative of the state of the port as manifested by the presence or absence of bits in a given LED register.

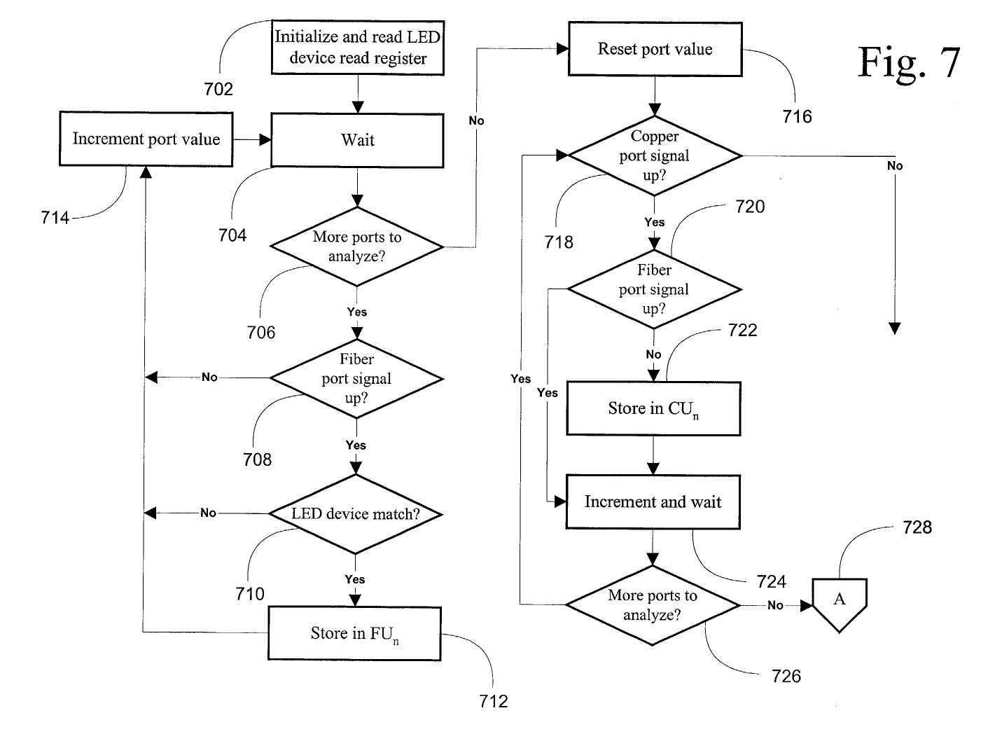

The registers provided by the present invention are used by the data switch system to automatically maintain data indicating the type of transmission medium connected at a port in a data switch device. FIG. 7 presents a flow diagram illustrating one embodiment of a method for initially determining the type of transmission medium connected to the ports comprising a data switch device. The method begins with initialization of the data switch device with all bits in the fiber up, copper up, and port mask registers set to a value used by the switch to indicate a false or empty state, step 702. At initialization, the switch also reads the bit values from the LED device read register to determine the ports comprising a physical connection, regardless of the transmission media attached to the port, step 702. The process performs a wait step whereby processing is suspended for a set amount of time, step 704. According to one embodiment of the invention, the wait step suspends processing for one millisecond. Alternatively, the wait step may be set to zero and bypassed altogether.

The process emerges from its wait state upon completion of the wait period, step 704, and a check is performed to determine if there are additional ports for analysis, step 706. Because this is the initial pass and the switch is analyzing the first port in the switch, there will typically be additional ports to analyze, causing the check to return true. Where there are additional ports to analyze, the current port's entry in the fiber signal register is examined to determine if the bit is set for the port, step 708. Where the fiber port signal is not set for the current port, step 708, the port value is increments, step 714, and the process is repeated for the next port in the data switch device.

Where a bit is set for the port's entry in the fiber signal register, step 708, a check is performed to determine if a bit is set for the port's entry in both the LED device read register and the link data register, step 710. If there is a matching bit set in the two registers for the given port a bit is set for the port's entry in the fiber up register, step 712. Regardless of whether the port's bit is set in the fiber up register, processing is directed to step 714 where the process is repeated for the next port in the data switch device.

Upon completion of the analysis of whether fiber transmission media is attached to each port in the data switch device, the check calculated at step 706 evaluates to false, causing control to pass to step 716. The port value is reset to the first port in the data switch device so that each port may be reexamined with regard to a copper transmission media connection, step 716. A check is performed to determine if a bit is set for the port's entry in the copper signal register, e.g., was copper the last transmission media attached to the selected port, step 718. If the check performed at step 718 evaluates to true, a “double check” is performed by the process to determine if a bit is set for the port's entry in the fiber signal register, step 720. Inclusion of this additional check is preferable in order to provide a preference for fiber transmission media connections, which provide superior bandwidth when compared to copper transmission media connection.

Where a bit is set for the port's entry in the copper signal register, step 718, and no bit is set for the port's entry in the fiber signal register, step 720, a bit is set for the port's entry in the copper up register, step 722. Where no bit is set for the port's entry in the copper signal register, step 718, program flow is directed to step 724 where the value of the current port is incremented and a wait is performed. Similarly, where a bit is set for the port's entry in both the copper and fiber signal registers, steps 718 and 720, the bit is not recorded for the port's entry in the copper up register because of a preference for high bandwidth fiber connections. Program flow is directed to step 724 where the value of the current port is incremented and a wait is performed. The process emerges from the wait state, step 724, and checks to determine if there are additional ports to analyze, step 726. If there are additional ports to analyze, steps 718, 720, 722, and 724 are repeated, otherwise processing is directed to step 728.

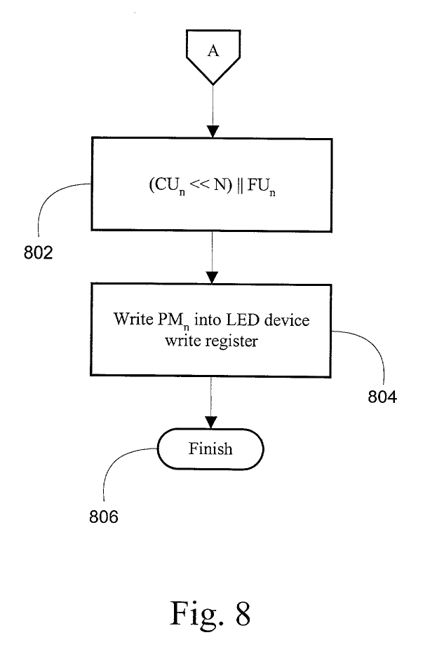

The process for initially determining the type of transmission medium connected to the ports comprising a data switch device continues with the flow diagram presented in FIG. 8. Upon completion of the method presented in FIG. 7, each of the fiber up and copper up registers maintained by the data switch system are populated with bits representing the type of transmission medium attached to each port on the data switch device. According to the embodiment of the registers presented in FIG. 6, both the copper up and fiber up registers comprise a plurality of four bit registers. These registers must be integrated to create a unified representation of the four port slot as a whole. Because the port mask register comprises a plurality of eight bit registers, one of the four bit registers, such as the copper up register, must have a bit shift operation applied to shift the bits into a position to occupy the higher four bits of the port mask register. A logical OR is applied to the bits in the fiber up and copper up registers, thereby moving the data into one unified register, step 802.

The bits of a selected register are shifted, and all the bits are copied into the port mask register, step 802. In the manner that the bits are transferred from the fiber and copper up registers into the port mask register, the higher four bits or the port mask register represent one type of transmission medium, e.g., copper, while the lower four bits represent the other transmission medium, e.g., fiber. The integrated port transmission media information is written to the LED device write register for use by applications that require the data, step 804. According to one embodiment, the LED device write register may be used to tell the data switch device which ports should be on or off. The data is written to the LED device write register, step 804, and the process conclude, step 806.

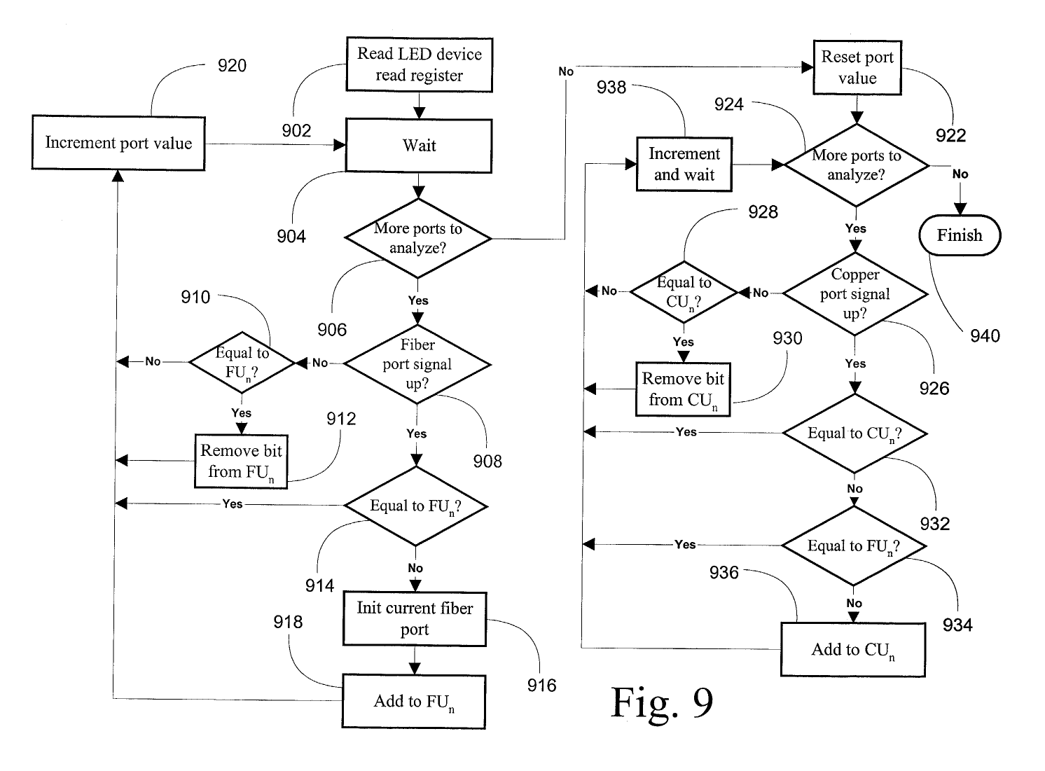

One embodiment of a method for automatically detecting and recording attachment or removal of fiber or copper transmission media is illustrated in FIG. 9. Software operating at the switch reads the bit values from the LED device read register to determine the ports that comprise a physical connection, regardless of the transmission media attached to the port, step 902. The process performs a wait step whereby processing is suspended for a set amount of time, step 904. Alternatively, the wait period may be set to zero, thereby bypassing the wait step.

The process emerges from its wait state upon completion of the wait period, step 904, and a check is performed to determine if there are additional ports for analysis, step 906. Where there are additional ports to analyze, the current port's entry in the fiber signal register is examined to determine if the bit is set for the port, step 908. If the bit is not set for the port in the fiber signal register, step 908, a check is performed to determine if a bit is set in the port's entry in the fiber up register, step 910. If the bit is set, it must be removed because the port is not registering a fiber connection, step 912. Regardless of whether a bit is set for the port's entry in the fiber up register, program flow is directed to step 920 where the current port being analyzed incremented and the process is reiterated.

If the bit is set for the port's entry in the fiber signal register, step 908, a check is performed to determine if a bit is correctly set for the port's entry in the fiber up register, step 914. Where the bit is properly set in the fiber up register, the port value is incremented and the process is reiterated, step 920. Where a bit is not set for the port's entry in the fiber up register, the port is initialized to accommodate a fiber transmission media connection, step 916. Initialization of a port to accommodate a fiber transmission media connection is a vendor specific operation, the details of which are outside the scope of the present disclosure. The port is initialized, step 916, and a bit is set for the port's entry in the fiber up register, step 918. The port value is incremented, step 920, and the process is reiterated.

Upon completion of the analysis of whether fiber transmission media is attached to each port in the data switch device, the check calculated at step 906 evaluates to false, causing control to pass to step 922. The port value is reset to the first port in the data switch device so that each port may be reexamined with regard to a copper transmission media connection, step 922. Where there are additional ports to analyze, step 924, a check is performed to determine if a bit is set in the port's entry in the copper signal register, e.g., was copper the last transmission media attached to the selected port, step 926.

If the bit is not set for the port in the copper signal register, step 926, a check is performed to determine if a bit is set in the port's entry in the copper up register, step 928. If the bit is set, it must be removed because the port is not registering a copper connection, step 930. Regardless of whether a bit is set for the port's entry in the copper up register, program flow is directed to step 938 where the current port being analyzed incremented, a wait is performed and the process is reiterated.

If the bit is set for the port's entry in the copper signal register, step 926, a check is performed to determine if a bit is correctly set for the port's entry in the copper up register, step 932. Where the bit is set in the copper up register, the port value is incremented and the process is reiterated, step 920. If, however, the check performed at step 932 indicates that a bit is not set for the port's entry in the copper up register (even though the port's bit is set in the copper signal register), an additional check is performed to determine if a bit is set for the port's entry in the fiber up register. If the checks performed at step 932 and 934 both evaluate to false, a bit is set for the port's entry in the copper up register, step 936. Where either check evaluates to true, program flow is directed to step 938 where the port value is incremented and the process repeated until all ports are analyzed, step 924, at which point the process concludes, step 940, until it is invoked again by the scheduling process.

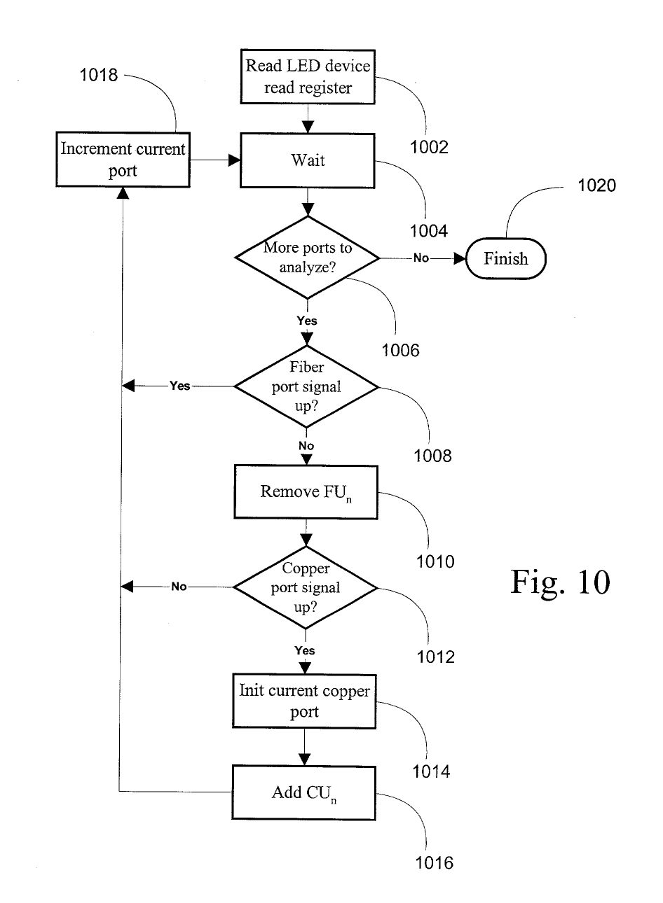

FIG. 10 presents an alternative embodiment to the process presented in FIG. 9 for automatically detecting and accounting for a switch from fiber to copper transmission media. Software operating at the switch reads the bit values from the LED device read register to determine the ports that comprise a physical connection, regardless of the transmission media attached to the port, step 1002. The process performs a wait step whereby processing is suspended for a set amount of time, step 1004. Alternatively, the wait period may be set to zero, thereby bypassing the wait step.

The process emerges from its wait state upon completion of the wait period, step 1004, and a check is performed to determine if there are additional ports for analysis, step 1006. Where there are additional ports to analyze, the current port's entry in the fiber signal register is examined to determine if the bit is set for the port, step 1008. If the bit is set for the port in the fiber signal register, step 1008, the port value is incremented, step 1018, and the process is reiterated. Where a bit is not set for the port's entry in the fiber signal register, step 1008, the bit contained in the port's corresponding entry in the fiber up register is removed, step 1010.

Processing continues by calculating whether a bit is set for the port's entry in the copper signal register, step 1012. Where a bit is set for the port's entry in the copper signal register, the port is initialized to accommodate a copper transmission media connection, step 1014. Initialization of a port to accommodate a copper transmission media connection is a vendor specific operation, the details of which are outside the scope of the present disclosure. The port is initialized, step 1014, and a bit is set for the port's entry in the copper up register, step 1016. Regardless of whether the check performed at step 1012 resolves to true or false, the port value is incremented, step 1018, and the process is reiterated. When all ports have been analyzed, step 1006, the process concludes, step 1020.

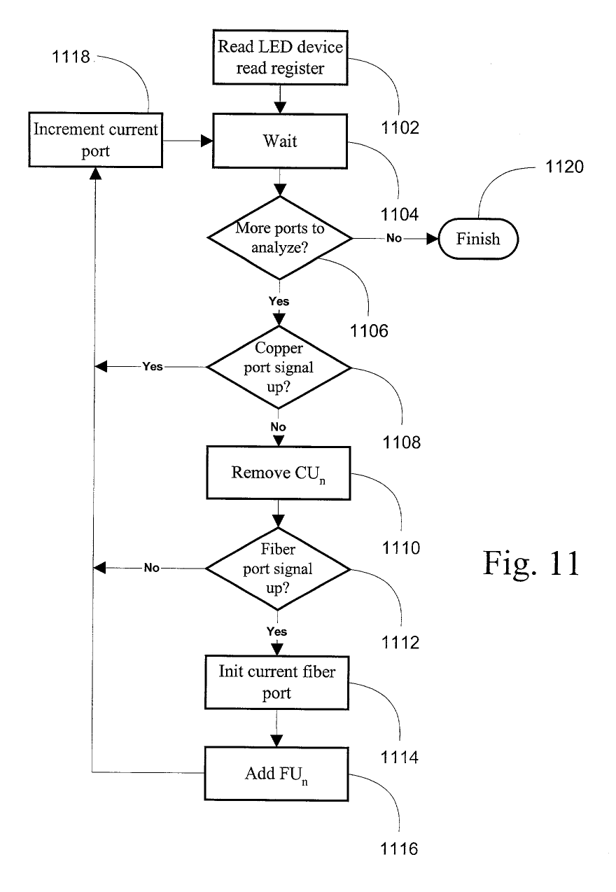

FIG. 11 presents another alternative embodiment to the process presented in FIG. 9 whereby the process automatically detects and accounts for a switch from fiber to copper transmission media. Software operating at the switch reads the bit values from the LED device read register to determine the ports that comprise a physical connection, regardless of the transmission media attached to the port, step 1102. The process performs a wait step whereby processing is suspended for a set amount of time, step 1104. According to one embodiment of the invention, the wait step suspends processing for one millisecond. Alternatively, the wait period may be set to zero, thereby bypassing the wait step.

The process emerges from its wait state upon completion of the wait period, step 1104, and a check is performed to determine if there are additional ports for analysis, step 1106. Where there are additional ports to analyze, the current port's entry in the copper signal register is examined to determine if the bit is set for the port, step 1108. If the bit is set for the port in the copper signal register, step 1108, the port value is incremented, step 1118, and the process is reiterated. Where a bit is not set for the port's entry in the copper signal register, step 1108, the bit contained in the port's corresponding entry in the copper up register is removed, step 1110.

Processing continues by calculating whether a bit is set for the port's entry in the fiber signal register, step 1112. Where a bit is set for the port's entry in the fiber signal register, step 1112, the port is initialized to accommodate a fiber transmission media connection, step 1114. Initialization of a port to accommodate a fiber transmission media connection is a vendor specific operation, the details of which are outside the scope of the present disclosure. The port is initialized, step 1114, and a bit is set for the port's entry in the fiber up register, step 1116. Regardless of whether the check performed at step 1112 resolves to true or false, the port value is incremented, step 1118, and the process is reiterated. When all ports have been analyzed, step 1106, the process concludes, step 1120.

According to embodiments of the invention, an additional check is performed when a bit is not set in both the copper and fiber signal registers for a given port. Lack of a set bit in both signal registers may be due to the fact that no device is physically connected to the given port. Alternatively, it may be symptomatic of a failure in the hardware used to detect the type of transmission media attached to a given port. For any given port without a bit set in the fiber and copper signal registers, a process is executed in parallel to the processes presented and explained in FIGS. 7 through 11 whereby software executed by the switch reinitializes the given port for copper transmission media at a set interval. For example, the switch may reinitialize the given port or ports at three-second intervals where no signal is detected in both the copper and fiber signal registers. Upon registering a signal in either the copper of fiber registers for a given port, the auto-recovery process terminates for the given port and the processes presented in the FIGS. 7 through 11 continue as indicated. It should further be noted that, this auto-recovery technique may be activated or deactivated by a user such as a switch administrator.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1.-29. (canceled)

30. An apparatus, comprising:
a network device that includes:
at least one port;
a link data register maintained in a memory space of a volatile memory and adapted to store data; and
at least one electronic device adapted to provide an output that represents whether a first transmission medium type or a second transmission medium type is connected to the at least one port, the provided output being based on the data stored in the link data register,
wherein the network device further includes program code executable by a processor to read the data stored in the link data register and to control the at least one electronic device to provide said output.

31. The apparatus of claim 30 wherein the stored data indicates a presence of flow through the at least one port, the apparatus further comprising a processor adapted to read the data stored in the link data register and adapted to determine, based on the stored data that indicates the presence of data flow through the at least one port, whether the first transmission medium type or the second transmission medium type is actively connected to the at least one port.

32. The apparatus of claim 31 wherein the processor is further adapted to determine whether the first transmission media type or the second transmission media type has been removed from the at least one port.

33. The apparatus of claim 30 wherein the network device includes a data switch device.

34. The apparatus of claim 30 wherein the at least one port includes a first port adapted to have connected thereto the first transmission medium type and a second port adapted to have connected thereto the second transmission media type, wherein the at least one electronic device includes a first electronic device and a second electronic device respectively corresponding to the first port and to the second port.

35. The apparatus of claim 30 wherein the at least one indicator includes at least one light emitting diode (LED) adapted to generate light as said provided output.

36. The apparatus of claim 30 wherein the first transmission medium type includes optical fiber and wherein the second transmission medium type includes copper.

37. An apparatus, comprising:
a network device that includes:
at least one port;
a link data register maintained in a memory space of a volatile memory and adapted to store data indicative of presence of data flow through the at least one port; and
at least one electronic device adapted to provide an output that represents whether a first transmission medium type or a second transmission medium type is connected to the at least one port, the provided output being based on the stored data indicative of presence of data flow,
wherein the network device further includes program code executable by a processor to read the data stored in the link data register and to control the at least one electronic device to provide said output.

38. The apparatus of claim 37 wherein the network device includes a data switch device.

39. The apparatus of claim 37 wherein the first transmission medium type includes optical fiber and wherein the second transmission medium type includes copper.

40. The apparatus of claim 37, further comprising a processor adapted to read the data stored in the link data register and adapted to determine, based on the read stored data indicative of presence of data flow, whether the first transmission medium type or the second transmission medium type is connected to the at least one port.

41. The apparatus of claim 40 wherein the processor is further adapted to determine whether the first transmission media type or the second transmission media type has been removed from the at least one port.

42. The apparatus of claim 37 wherein the at least one port includes a first port adapted to have connected thereto the first transmission medium type and a second port adapted to have connected thereto the second transmission media type, and wherein the at least one electronic device includes a first electronic device and a second electronic device respectively corresponding to the first port and to the second port.

43. The apparatus of claim 37 wherein the at least one indicator includes at least one light emitting diode (LED) adapted to generate light as said provided output.

44. A method, comprising:
storing, in a link data register maintained in a memory space of a volatile memory of a network device, data indicative of presence of data flow through at least one port of the network device;
reading the data stored in the link data register; and
if said reading the data determines that data flow through the at least one port is present, providing an output that represents whether a first transmission medium type or a second transmission medium type is connected to the at least one port,
wherein the network device further includes program code executable by a processor to perform said reading the data stored in the link data register and to control said providing said output.

45. The method of claim 44 wherein the network device includes a data switch device.

46. The method of claim 44, further comprising determining whether the first transmission media type or the second transmission media type has been removed from the at least one port.

47. The method of claim 44 wherein the first transmission medium type includes optical fiber and wherein the second transmission medium type includes copper.

48. The method of claim 44 wherein said providing the output includes generating light as said provided output.
